(19) United States
(12) Patent Application Publication
(10) Pub. No.: US 2024/0199787 A1
(43) Pub. Date: Jun. 20, 2024

(54) METHOD FOR THE PRODUCTION OF AN ISOCYANATE-GROUP TERMINATED POLYOXAZOLIDINONE COMPOSITION

(71) Applicant: Covestro Deutschland AG, Leverkusen (DE)

(72) Inventors: Stefan Westhues, Leverkusen (DE); Aurel Wolf, Wülfrath (DE); Kai Laemmerhold, Odenthal (DE); Irene Cristina Latorre Martinez, Leverkusen (DE); Christoph Guertler, Köln (DE); Jan Weikard, Leverkusen (DE); Laura Woods, Düsseldorf (DE); Michael Ludewig, Odenthal (DE)

(21) Appl. No.: 18/287,562

(22) PCT Filed: Apr. 20, 2022
(86) PCT No.: PCT/EP2022/060332

§ 371 Date: Oct. 19, 2023

(30) Foreign Application Priority Data
Apr. 26, 2021 (EP) 21170564.5
Nov. 2, 2021 (EP) 21205940.6

(51) Int. Cl. C08G 18/00; C08G 18/10; C08G 18/16

(52) U.S. Cl. CPC C08G 18/003; C08G 18/10; C08G 18/168

(57) ABSTRACT

The invention is related to a process for producing an isocyanate-group terminated polyoxazolidinone composition comprising the copolymerization of a polyisocyanate compound with two or more isocyanate groups with a polyepoxide compound with two or more epoxy groups in the presence of phosphorous and/or antimony catalyst, wherein the molar ratio of the isocyanate groups of the polyisocyanate compound to the epoxy groups of the polyepoxide compound is larger than 2:1 and less than 25:1, and wherein the process is conducted in the absence of a solvent with a boiling point higher than 200° C., at 1 bar (absolute). The invention is also related to the resulting isocyanate-group terminated polyoxazolidinone compositions and a process for producing an isocyanate-group terminated polyoxazolidinone by removal of a solvent and/or unreacted polyisocyanate compound.

### CROSS REFERENCE TO RELATED APPLICATIONS

This application is a U.S. national stage application, filed under 35 U.S.C. §371. of International Application No. PCT/EP2022/060332, which was filed on Apr. 20. 2022. and which claims priority to European Patent Application No. 21205940.6, which was filed on Nov. 2, 2021. and to European Patent Application No. 21170564.5 which was filed on Apr. 26, 2021. The contents of each are hereby incorporated by reference into this specification.

### FIELD

The invention is related to a process for producing an isocyanate-group terminated polyoxazolidinone composition comprising the copolymerization of a polyisocyanate compound with two or more isocyanate groups with a polyepoxide compound with two or more epoxy groups in the presence of phosphorous and/or antimony catalyst, wherein the molar ratio of the isocyanate groups of the polyisocyanate compound to the epoxy groups of the polyepoxide compound is larger than 2:1 and less than 25:1, and wherein the process is conducted in the absence of a solvent with a boiling point higher than 200° C. at 1 bar (absolute). The invention is also related to the resulting isocyanate-group terminated polyoxazolidinone compositions and a process for producing an isocyanate-group terminated polyoxazolidinone by removal of a solvent and/or unreacted polyisocyanate compound.

### BACKGROUND

Oxazolidinones are widely used structural motifs in pharmaceutical applications and the cycloaddition of epoxides and isocyanates seems to be a convenient one-pot synthetic route to it. Expensive catalysts, reactive polar solvents, long reaction times and low chemoselectivities are common in early reports for the synthesis of oxazolidinones (M. E. Dyen and D. Swern, Chem. Rev., 67,197,1967). Due to these disadvantages there was the need for alternative methods for the production of oxazolidinones especially for application of oxazolidinones as structural motif in polymer applications.

The scientific publication J. Polym. Sci. 8 (1970) 2759-2773 discloses polyoxazolidinones prepared from various bisepoxides and various diisocyanates in the presence of alkaline metal halide catalysts. A solution of equimolar bisepoxide and diisocyanate amounts is added dropwise to a reactor containing a LiCl catalyst dissolved in DMF under reflux conditions within 1 h and a subsequent post reaction of 12 to 23 h was carried out under reflux conditions in order to complete the reaction. U.S. Pat. No. 4,129,695 A teaches a polymer comprising oxazolidinone and carbodiimide prepared from polyisocyanates and polyepoxides, wherein these compounds can be a diisocyanate or a diepoxide, wherein the ratio of number of isocyanate groups to the number of epoxide groups is between 1.1:1 and 20:1, preferably 1.2:1 and 10:1, wherein tertiary aliphatic, cycloaliphatic and aromatic amines. such as triethylene diamine (DABCO) were applied as catalyst for the oxazolidinone formation.

In Flores et al. (Thermochmica Acta (Elsevier) Vol. 543 (2012) pages 188 to 196) disclose a producing isocyanate-group terminated polyoxazolidinone reacting 4-toluene-2,4-diisocyanate with a diglycedylether of Bisphenol A in the presence of ytterbium triflate, wherein the molar ratio of 4-toluene-2,4-diisocyanate to the diglycedylether of Bisphenol A is 2:1.

In Pelzer et al. (European Polymer Journal 107 (2018)) oxazolidinone formation was investigated by reaction of 4,4-methylene diphenyl diisocyanate (MDI) with o-cresyl glycidyl ether (OGCE) or Bisphenol A diglycidyl ether (BADGE) in the presence of various tetra-n-butyl ammonium halides. wherein molar BADGE to MDI ratios from 1 to 3 up to 3 to 1 were applied. However, significant amounts of side products. i.e. isocyanurates, were detected operating at a BADGE to MDI ratios of 3 to 1 forming epoxy-terminated oxazolidinones. If a molar BADGE to MDI ratio of 1 to 3 was applied no isocyanate-terminated oxazolidinone formation were possible in the presence of the applied tetra-n-butyl ammonium halide catalysts.

WO 2020/249472 A1 discloses a process for producing an isocyanate-group terminated polyoxazolidinone comprising the copolymerization of a polyisocyanate compound with two or more isocyanate groups with a polyepoxide compound with two or more epoxy groups in the presence of a catalyst (C) and in a solvent, wherein LiCl or LiBr as alkali metal halogenides were applied as catalysts in a mixture of ortho-dichlorobenzene and sulfolane as solvents.

In US 2017/081462 A1 relates to a method for the selective production of oxazolidinone compounds with high activities, comprising the step of reacting an isocyanate compound with an epoxide compound in the presence of an onium salt as catalyst and to the oxazolidinone compounds obtainable by said method.

WO 86/06734 A1 disclose a process by which a polyepoxide and a polyisocyanate are reacted to form a polyoxazolidone, wherein the said reaction is conducted in the presence of a catalytic amount of an organoantimony iodide catalyst like triphenyl antimony iodide. Objective of the present invention was to identify a simple process for the preparation of isocyanate-group terminated polyoxazolidinone compositions and isocyanate-group terminated polyoxazolidinone (prepolymers) with defined isocyanate equivalent weights preferably in combination with a low polydispersity for further polymerization applications. In this context, side reactions, e.g. by formation of isocyanurates or polyurethanes should be significantly reduced or beneficially be avoided. Thus, an increased oxazolidinone to isocyanate (trimer) ratio compared to state of the art systems are beneficial. In addition, the oxazolidinone products should have a similar low coloring or preferably even be less colored with respect to systems described in prior art. Such isocyanate-group terminated polyoxazolidinones prepolymer systems should be also meltable for further polymerization applications.

In addition, high amounts of high boiling solvent causes energy-intensive and time-consuming removal process e.g. by distillation, and can negatively impact subsequent extrusion and injection molding processes of the polyoxazolidinones, such as unwanted foaming, unsuitable viscosity and explosive atmosphere. Therefore, the solvent that is in general necessary for the synthesis of the polyoxazolidinone should be quantitatively removed e.g. by distillation.

### SUMMARY

Surprisingly, it has been found that the problem can be solved by a process for producing an isocyanate-group terminated polyoxazolidinone composition comprising copolymerizing of a polyisocyanate compound (A) with two or more isocyanate groups with a polyepoxide compound (B) with two or more epoxy groups in the presence of a catalyst (C) and optionally in a solvent (D): wherein the molar ratio of the isocyanate groups of the polyisocyanate compound (A) to the epoxy groups of the polyepoxide compound (B) is larger than 2:1 and less than 25:1: and wherein the catalyst (C) is represented by the formula (I)

[M(R1)(R2)(R3)(R4)]⁺ₙYⁿ⁻ (I)

wherein M is phosphorous or antimony, preferred phosphorous,
wherein (R1), (R2), (R3), and (R4) are each, independently of one another a linear or branched alkyl groups containing 1 to 22 carbon atoms, optionally substituted with one or more heteroatoms, heteroatom containing substituents, or a combination thereof; a cycloaliphatic groups containing 3 to 22 carbon atoms, optionally substituted with one or more heteroatoms, heteroatom containing substituents, or a combination thereof; a C1 to C3 alkyl-bridged cycloaliphatic groups containing 3 to 22 carbon atoms, optionally substituted with one or more heteroatoms, heteroatom containing substituents, or a combination thereof; or an aryl groups containing 6 to 18 carbon atoms, optionally substituted with one or more alkyl groups containing 1 to 10 carbon atoms one or more heteroatom containing substituents one or more heteroatoms, or a combination thereof, wherein Y is a halide, carbonate, nitrate, sulfate or phosphate anion, more preferred a halide or carbonate and
wherein n is an integer of 1 2 or 3,
and wherein the process is conducted in the absence of a solvent (E) with a boiling point higher than 200° C. preferably higher than 190° C. and more preferably higher than 180° C. at 1 bar (absolute).

### DETAILED DESCRIPTION

As used herein, the term “polyoxazolidinone” is meant to denote compounds containing at least two oxazolidinone groups in the molecule. The term “isocyanate-group terminated” polyoxazolidinone is related to polyoxazolidinone compounds, wherein the molar ratio of the isocyanate groups of the polyisocyanate compound (A) to the epoxy groups of the polyepoxide compound (B) is larger than 2:1, so no terminal epoxy groups are present within the polyoxazolidinone compound according to the present invention.

As used herein, the term “polyoxazolidinone composition” is meant to denote a composition that comprises the isocyanate-group terminated polyoxazolidinone and the solvent (D) and/or unreacted polyisocyanate compound (A) if the solvent (D) is present.

All embodiments of the present invention can be combined unless the logical teaching clearly suggests that the embodiments cannot be combined.

In an embodiment of the method according to the invention the copolymerization process is performed at a reaction temperature of ≥130° C. to ≤280° C., preferably at a temperature of ≥ 140° C. to ≤240° C., more preferred at a temperature of ≥155° C. to ≤210° C. If temperatures below 130° C. are set, the reaction is generally very slow. At temperatures above 280° C., the amount of undesirable secondary products increases considerably.

In an embodiment of the method according to the invention the copolymerization process is performed at reaction times of 5 min to 20 h, preferably at 10 min to 10 h and more preferably at 15 min to 6 h.

As used herein, the term “polyisocyanate compound” is meant to denote compounds having two or more isocyanate groups.

In an embodiment of the method according to the invention, the polyisocyanate compound (A) is an aliphatic polyisocyanate compound (A-1) and/or an aromatic polyisocyanate compound (A-2), preferably an aliphatic polyisocyanate compound (A-1).

In an embodiment of the method according to the invention, the polyisocyanate compound (A) is at least one polyisocyanate accessible in various ways, for example by phosgenation in the liquid or gas phase or by a phosgene-free route, for example by thermal urethane cleavage.

In an embodiment of the method according to the invention, the polyisocyanate compound (A) is at least one compound selected from the group consisting of polyisocyanates from the molecular weight range of 140 g/mol to 600 g/mol having aliphatically and/or aromatically bonded isocyanate groups, examples being 1,4-diiocyanatobutane, 1,5-diisocyanatopentane (pentamethylene diisocyanate, PDI), 1,6-diisocy anatohexane (hexamethy lene HDI), 2-methyl-1,5-diisocyanate, diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,12-diisocyanatododecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4′- and 4,4′-diisocyanatodicyclohexylmethane (H12-MDI), 4,4′-diisocyanato-2,2-dicyclohexyl propane, 1-isocyanato-1-methyl-4(3)isocyanatomethylcyclohexane, bis(isocyanatomethyl)norbornane, or any polyisocyanates having uretdione, isocyanurate, allophanate, biuret, iminooxadiazinedione and/or oxadiazinetrione structure, prepared by modification of simple aliphatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0) 339 396 and EP-A 0) 798 299 or by mixtures of at least two such polyisocyanates, and 1,3- and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3bis(iscy anatomethyl)-2,4,6-trimethlybenzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatocthyl)benzene and 1,4-bis(isocyanatomethyl)naphthalene, 1,2-1,3- and 1,4-diisocyanatobenzene (phenylene diisocyanate), 2,4- and 2,6-diisocyanatotoluene (toluene diisocyanate, TDI), 2,3,5,6-tetramethyl-1,4-diisocyanatobenzene, the isomeric diethylphenylene diisocyanates, diisopropylphenylene diisocyanates, diisododecylphenylene diisocyanates and biphenyl diisocyanates, 3,3′-dimethoxy biphenyl-4,4′-diisocyanate, 2,2′, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI), diphenylether diisocyanate, ethylene glycol diphenylether diisocyanate, diethylene glycol diphenylether diisocyanate, 1,3-propylene glycol diphenylether diisocyanate, benzophenone diisocyanate, triisocyanatobenzenc, 2,4,6-triisocyanatotoluene, trimethylbenzene triisocyanate, diphenylmethane-2,4,4′-triisocyanate, 3-methyldiphenylmethane-4,6,4′-triisocyanate, the isomeric naphthalene triisocyanates and methy lnaphthalene diisocyanates, triphenylmethane triisocyanatc, 2,4-diisocyanato-1-[(5-isocyanato-2-methylphenyl)methyl]benzene, 4-methyl-diphenylmethane-3,5,2′,4′,6′-pentaisocyanate, and also the polynuclear homologues of diisocyanatodiphenylmethane known as “polymer-MDI”, and also the polyisocyanates having urethane and/or isocyanurate structures obtainable from monomeric 2,4- and/or 2,6-TDI by reaction with polyols and/or oligomerization, preferably trimerization, which are obtainable by any known methods, described for example in DE-A 870 400, DE-A 953 012, DE-A 1 090 196, EP-A 0 546 399, CN 105218780, CN 103881050, CN 101717571, U.S. Pat. No. 3,183,112, EP-A 0416 338, EP-A 0 751 163, EP-A 1 378 529, EP-A 1 378 530, EP-A 2 174 967, JP 63260915 or JP 56059828 or are mixtures of at least two such polyisocyanates, and also those polyisocynanate compounds bearing both aromatic and aliphatic isocyanate groups, for example the mixed trimers or allophanates of 2,4- and/or 2,6-TDI with HDI described in DE-A 1 670 667, EP-A 0) 078 991, EP-A 0 696 606 and EP-A 0 807 623.

More preferred, the polyisocyanate compound (A) is at least one compound selected from the group consisting of polyisocyanates from the molecular weight range of 140 g/mol to 600 g/mol having aliphatically and/or aromatically bonded isocyanate groups, examples being 1,4-diisocyanatobutane, 1,5-diisocyanatopentane (pentamethylene diisocyanate, PDI), 1,6-diisocyanatohexane (hexamethylene diisocyanate, HDI), 1,5-diisocyanato-2,2-dimethylpentane, 2,2,4- or 2,4,4-trimethyl-1,6-diisocyanatohexane, 1,8-diisocyanatooctane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4′- and 4,4′-diisocyanatodicyclohexylmethane (H12-MDI), 4,4′-diisocyanato-2,2-dicyclohexyl propane, or any polyisocyanates having uretdione, isocyanurate, allophanate, biuret, iminooxadiazinedione and/or oxadiazinetrione structure, prepared by modification of simple aliphatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209,DE-A 3 900 053 and DE-A 3 928 503 or in EP-A 0 336 205, EP-A 0) 339 396 and EP-A 0) 798 299, and 1,3- and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3-bis(iscyanatomethyl)-2,4,6-trimethly benzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,4-bis(2-isocyanatoethyl)benzene, 1,4-bis(isocyanatomethyl)naphthalene, 1,2-, 1,3- and 1,4-diisocyanatobenzene (phenylene diisocyanate), 2,4- and 2,6-diisocyanatotoluene (toluene diisocyanate, TDI), 2,3,5,6-tetramethyl-1,4-diisocyanatobenzene, diisopropylphenylene diisocyanates, diisododecylphenylene diisocyanates and biphenyl diisocyanates, 3,3′-dimethoxy bipheny 1-4,4′-diisocyanate, 2,2 -, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI), diphenylether diisocyanate, ethylene glycol diphenylether diisocyanatc, 1,3-propylene glycol diphenylether diisocyanate, triisocyanatobenzene, 2,4,6-triisocyanatotoluene, trimethylbenzene triisocyanate, 3-methyldiphenylmethane-4,6,4′-triisocyanate, the isomeric naphthalene triisocyanates and methylnaphthalene diisocyanates, triphenylmethane triisocyanate, 2,4-diisocyanato-1-[(5-isocyanato-2-methylphenyl)methyl]benzene and also the polynuclear homologues of diisocyanatodiphenylmethane known as “polymer-MDI”, and also the polyisocyanates having urethane and/or isocyanurate structures obtainable from monomeric 2,4- and/or 2,6-TDI by reaction with polyols and/or oligomerization, preferably trimerization, which are obtainable by any known methods, described for example in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915 or JP 56059828, and also those polyisocynanate compounds bearing both aromatic and aliphatic isocyanate groups, for example the mixed trimers or allophanates of 2,4- and/or 2,6-TDI with HDI described in DE-A 1 670 667, EP-A 0 078 991, EP-A 0 696 606 and EP-A 0 807 623,

And most preferred, the polyisocyanate compound (A) is at least one compound selected from the group consisting of polyisocyanates from the molecular weight range of 140 g/mol to 600 g/mol having aliphatically and/or aromatically bonded isocyanate groups, examples being 1,5-diisocyanatopentane (pentamethylene diisocyanate, PDI), 1,6-diisocyanatohexane (hexamethylene diisocyanate, HDI), 1-isocyanato-3,3,5-trimethyl-5-isocyanatomethylcyclohexane (isophorone diisocyanate, IPDI), 2,4′- and 4,4′-diisocyanatodicyclohexylmethane (H12-MDI), and 1,3- and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 2,2′-, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI).

A mixture of two or more of the aforementioned polyisocyanate compounds (A) can also be used.

As used herein, the term “aliphatic polyisocyanate compound” is meant to denote compounds having two or more isocyanate groups and aliphatic moieties and can contain aromatic moieties. The aliphatic polyisocyanate compound means an linear aliphatic or a cycloaliphatic polyisocyanate compound. Within the aliphatic polyisocyanate compound the isocyanate moiety is not directly bound to the aromatic moiety. Xylylene diisocyanate (XDI) is an example of an aliphatic polyisocyanate with isocyanate moieties which are not directly bound to the aromatic moiety, wherein the isocyanate group is bound through a methylene group to the phenyl group. In a preferred embodiment of the method according to the invention the polyisocyanate compound (A) is an aliphatic (A-1).

In an embodiment of the method according to the invention, the aliphatic polyisocyanate compound (A-1) is at least one compound selected from the group consisting of polyisocyanates from the molecular weight range of 140 g/mol to 400 g/mol having aliphatically bonded isocyanate groups, examples being 1,4-diisocyanatobutane, 1,5-diisocyanatopentane (pentamethylene diisocyanate, PDI), 1,6-diisocyanatohexane (hexamethylene diisocyanate, HDI), 2-methyl-1,5-diisocyanatopentane, 1,5-diisocyanato-2,2-dimethylpentane, 2,2,4- or 2,4,4-trimethyl-1,6-diisocyanatohexane, 1,8-diisocyanatooctane, 1,10-diisocyanatodecane, 1,12-diisocyanatododecane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4′-and 4,4′-diisocyanatodicyclohexylmethane (H12-MDI), 4,4′-diisocyanato-2,2-dicyclohexyl propane, 1-isocyanato-1-methyl-4(3)isocyanatomethylcyclohexane, bis(isocyanatomethyl)norbornane, 1,3-and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3bis(iscyanatomethyl)-2,4,6-trimethly benzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene and 1,4-bis(isocyanatomethyl)naphthalene, or any polyisocyanates having uretdione, isocyanurate, allophanate, biuret, iminooxadiazinedione and/or oxadiazinetrione structure, prepared by modification of simple aliphatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299 or by mixtures of at least two such polyisocyanates.

More preferred, the aliphatic polyisocyanate compound (A-1) is at least one compound selected from the group consisting of polyisocyanates from the molecular weight range of 140 g/mol to 400 g/mol having aliphatically bonded isocyanate groups, examples being 1,4-diisocyanatobutane, 1,5-diisocyanatopentane (pentamethylene diisocyanate, PDI), 1,6-diisocyanatohexane (hexamethylene diisocyanate, HDI), 1,5-diisocyanato-2,2-dimethylpentane, 2,2,4- or 2,4,4-trimethyl-1,6-diisocyanatohexane, 1,8-diisocyanatooctane, 1,3- and 1,4-diisocyanatocyclohexane, 1,3- and 1,4-bis(isocyanatomethyl)cyclohexane, 1-isocyanato-3,3,5-trimethyl-5-isocyanatomethylcyclohexane (isophorone diisocyanate, IPDI), 2,4-and 4,4′-diisocyanatodicyclohexylmethane (H12-MDI), 4,4′-diisocyanato-2,2-dicyclohexyl propane, 1,3- and 1,4-bis(isocyanatomethyl)benzene (xylylene diisocyanate, XDI), 1,3- and 1,4-bis(2-isocyanatopropan-2-yl)benzene (tetramethylxylylene diisocyanate, TMXDI), 1,3-bis(isocyanatomethyl)-4-methylbenzene, 1,3-bis(isocyanatomethyl)-4-ethylbenzene, 1,3-bis(isocyanatomethyl)-5-methylbenzene, 1,3bis(iscyanatomethyl)-2,4,6-trimethly benzene, 1,3-bis(isocyanatomethyl)-4,5-dimethylbenzene, 1,4-bis(isocyanatomethyl)-2,5-dimethylbenzene, 1,4-bis(isocyanatomethyl)-2,3,5,6-tetramethylbenzene, 1,3-bis(isocyanatomethyl)-5-tert-butylbenzene, 1,3-bis(isocyanatomethyl)-4-chlorobenzene, 1,3-bis(isocyanatomethyl)-4,5-dichlorobenzene, 1,3-bis(isocyanatomethyl)-2,4,5,6-tetrachlorobenzene, 1,4-bis(isocyanatomethyl)-2,3,5,6-tetrachlorobenzene, 1,4-bis(isocyanatomethyl)-2,3,5,6-tetrabromobenzene, 1,4-bis(2-isocyanatoethyl)benzene and 1,4-bis(isocyanatomethyl)naphthalene, or any polyisocyanates having uretdione, isocyanurate, allophanate, biuret, iminooxadiazinedione and/or oxadiazinetrione structure, prepared by modification of simple aliphatic diisocyanates, for example those of the type mentioned above, as described for example in J. Prakt. Chem. 336 (1994) 185-200, in DE-A 1 670 666, DE-A 1 954 093, DE-A 2 414 413, DE-A 2 452 532, DE-A 2 641 380, DE-A 3 700 209, DE-A 3 900 053 and DE-A 3 928 503 or in EP-A 0 336 205, EP-A 0 339 396 and EP-A 0 798 299 or by mixtures of at least two such polyisocyanates.

And most preferred, the aliphatic polyisocyanate compound (A-1) is one or more compound(s) and selected from the group consisting of 1,5-diisocyanatopentane (pentamethylene diisocyanate PDI), 1,6-diisocyanatohexane (hexamethylene diisocyanate, HDI), and 1-isocyanato-3,3,5-trimethyl-5-isocyanatomethylcyclohexane (isophorone diisocyanate, IPDI).

A mixture of two or more of the aforementioned aliphatic polyisocyanate compound (A-1) can also be used.

As used herein, the term “aromatic polyisocyanate compound” is meant to denote compounds having two or more isocyanate groups and must contain aromatic and can additionally contain aliphatic moieties. Thereby, the term “aromatic polyisocyanate compound” is meant to denote compounds bearing two or more isocyanate groups which are directly bound to the aromatic moiety e.g. 2,4- and 2,6-diisocy anatotoluene (toluene diisocyanate, TDI) or 2,2′-, 2,4′- and 4,4′-diisocyanatodiphenylmethane (MDI). In a less preferred embodiment of the method according to the invention the polyisocyanate compound (A) is an aromatic polyisocyanate compound (A-2).

In a preferred embodiment of the method according to the invention, the aromatic polyisocyanate compound (A-2) is at least one compound and is selected from the group consisting of aromatic diisocyanates and triisocyanateare of the molecular weight range from 160 g/mol to 600 g/mol, such as 1,2-, 1,3- and 1,4-diisocyanatobenzene (phenylene diisocyanate), 2,4- and 2,6-diisocyanatotoluene (toluene diisocyanate, TDI), 2,3,5,6-tetramethyl-1,4-diisocyanatobenzene, diisopropylphenylene diisocyanates, diisododecylphenylene diisocyanates and biphenyl diisocyanates, 3,3′-dimethoxy biphenyl-4,4′-diisocyanate, 2,2° -, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI), diphenylether diisocyanate, ethylene glycol diphenylether diisocyanate, 1,3-propylene glycol diphenylether diisocyanate, trimethylbenzene triisocyanate, 3- triisocyanatobenzene, 2,4,6-triisocyanatotoluene, methyldiphenylmethane-4,6,4′-triisocyanate, the isomeric naphthalene triisocyanates and methy lnaphthalene diisocyanates, triphenylmethane triisocyanate, 2,4-diisocyanato-1-[(5-isocyanato-2-methylphenyl)methyl]benzene and also the polynuclear homologues of diisocyanatodiphenylmethane known as “polymer-MDI”, and also the polyisocyanates having urethane and/or isocyanurate structures obtainable from monomeric 2,4- and/or 2,6-TDI by reaction with polyols and/or oligomerization, preferably trimerization, which are obtainable by any known methods, described for example in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915 or JP 56059828.

In a more preferred embodiment of the method according to the invention, the aromatic polyisocyanate compound (A-2) is at least one compound and is selected from the group consisting of aromatic diisocyanates and triisocyanates of the molecular weight range from 160 g/mol to 600 g/mol, such as 1,2 -, 1,3- and 1,4-diisocyanatobenzene (phenylene diisocyanate), 2,4- and 2,6-diisocyanatotoluene (toluene diisocyanate, TDI), 2,3,5,6-tetramethyl-1,4-diisocyanatobenzene, the isomeric diethy lpheny lene diisocyanates, diisopropylpheny lene diisocyanates, diisododecylphenylene diisocyanates and biphenyl diisocyanates, 3,3′-dimethoxy biphenyl-4,4′-diisocyanate, 2,2′-, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI), dipheny lether diisocyanate, ethyhene glycol dipheny lether diisocyanate, diethylene glycol diphenylether diisocyanate, 1,3-propylene glycol diphenylether diisocyanate, benzophenone diisocyanate, triisocyanatobenzene, 2,4,6-triisocyanatotoluene, trimethylbenzene triisocyanate, diphenylmethane-2,4,4′-triisocyanate, 3-methyldiphenylmethane-4,6,4′-triisocyanate, the isomeric naphthalene triisocyanates and methylnaphthalene diisocyanates, triphenylmethane triisocyanate, 2,4-diisocyanato-1-[(5-isocyanato-2-methylphenyl)methyl]benzene, 4-methyl-diphenylmethane-3,5,2′,4′,6′-pentaisocyanate, and also the polynuclear homologues of diisocyanatodiphenylmethane known as “polymer-MDI”, and also the polyisocyanates having urethane and/or isocyanurate structures obtainable from monomeric 2,4- and/or 2,6-TDI by reaction with polyols and/or oligomerization, preferably trimerization, which are obtainable by any known methods, described for example in DE-A 870 400, DE-A 953 012, DE-A 1 090 196, EP-A 0 546 399, CN 105218780, CN 103881050, CN 101717571, U.S. Pat. No. 3,183,112, EP-A 0 416 338, EP-A 0 751 163, EP-A 1 378 529, EP-A 1 378 530, EP-A 2 174 967, JP 63260915 or JP 56059828 or are mixtures of at least two such polyisocyanates.

In a most preferred embodiment of the method according to the invention, the aromatic polyisocyanate compound (A-2) is at least one compound and is selected from the group consisting of 2,2′ -, 2,4′- and 4,4′-diisocyanatodiphenylmethane (MDI), 3,3′-dimethyl diphenylmethane-4,4′-diisocyanate, 4,4′-diisocyanatodiphenylethane, 1,5-diisocyanatonaphthalene (NDI) and 2,4 -, and 2,6-diisocyanatetoluene (TDI).

A mixture of two or more of the aromatic polyisocyanate compounds (A-2) can also be used.

As used herein, the term “polyepoxide compound” is meant to denote compounds having two or more epoxide groups.

In a preferred embodiment of the invention, the polyepoxide compound (B) is an aliphatic polyepoxide compound (B-1) and/or aromatic polyepoxide compound (B-2), preferably aliphatic polyepoxide compound (B-1).

In a preferred embodiment of the invention, the epoxide compound (B) is at least one compound selected from the group consisting of resorcinol diglycidyl ether, neopentyl glycol diglycidyl ether, 1,6-hexanediol diglycidyl ether, 1,4-butandiol diglycidyl ether, hydrogenated bisphenol A diglycidyl ether, bisphenol A diglycidyl ether, bisphenol F diglycidyl ether, bisphenol S diglycidyl ether, 9,9-bis(4-glycidy loxy phenyl)fluorine, tetrabromo bisphenol A diglycidyl ether, tetrachloro bisphenol A diglycidyl ether, tetramethyl bisphenol A diglycidyl ether, tetramethyl bisphenol F diglycidyl ether, tetramethyl bisphenol S diglycidyl ether, diglycidyl terephthalate, diglycidyl o-phthalate, trimellitic acid triglycidyl ester, 1,4-cyclohexane dicarboxylic acid diglycidyl ester, ethylene glycol diglycidyl ether, polyethylene glycol diglycidyl ether, diethylene glycol diglycidyl ether, propylene glycol diglycidyl ether, dipropylene glycol diglycidyl ether, polypropylene glycol diglycidyl ether, poly butadiene diglycidyl ether, polybutadiene diepoxide, glycerol triglycidyl ether, polyglycerol polyglycidyl ether, polyglycidyl ether of ethoxylated trimethylolpropane, poly (tetramethylene-oxid) diglycidyl ether, pentaeritrol polyglycidyl ether, vinylcyclohexene diepoxide, limonene diepoxide, the diepoxides of double unsaturated fatty acid C1-C18 alkyl esters, polyepoxides of double unsaturated ethoxylated fatty alcohols, 2-dihydroxybenzene diglycidyl ether, 1,4-dihydroxybenzene diglycidyl ether, 4,4′-(3,3,5-trimethylcyclohexyliden)bisphenyl diglycidyl ether and diglycidyl isophthalate, tetrabromobisphenol A diglycidyl ether, cardanol-based diglycidyl ether, Hydrochinone diglycidyl ether, 4,4′-dihydroxy benzene diglycidyl ether, Bis-(4-hydroxyphenyl)-1,1-ethane diglycidyl ether, Bis-(4-hydroxyphenyl)-1,1-isobutane diglycidyl ether, Bis-(4-hydroxyphenyl) ether diglycidyl ether, as well as chlorinated and brominated varieties of the aforementioned components.

Aliphatic di- or polyglycidyl ether, derived via epoxidation of di- or polyfunctional alcohols with aliphatic linear, aliphatic branched, or cycloaliphatic moieties consisting of 2-40 carbon atoms, for example ethanediol diglycidyl ether, propanediol diglycidyl ether, isosorbidediglycidyl ether, octanediol diglycidyl ether, trimethylolpropane polyglycidyl ether, glycerol polyethylene triglycidyl ether, 2-ethyl hexyl diglycidyl ether.

More preferred the polyepoxide compound (B) is selected from the group consisting of neopentyl glycol diglycidyl ether, hydrogenated bisphenol A diglycidyl ether, 1,4-cyclohexane dicarboxylic acid diglycidyl ester, ethylene glycol diglycidyl ether, polyethylene glycol diglycidyl ether, diethylene glycol diglycidyl ether, propylene glycol diglycidyl ether, dipropylene glycol diglycidyl ether, polypropylene glycol diglycidyl ether, glycerol triglycidyl ether, polyglycerol polyglycidyl ether, polyglycidyl ether of ethoxylated trimethylolpropane, poly (tetramethy lene-oxid) diglycidyl ether, pentaeritrol polyglycidyl ether, vinylcyclohexene diepoxide, the diepoxides of double unsaturated fatty acid C1-C18 alkyl esters, polyepoxides of double unsaturated ethoxy lated fatty alcohols, Aliphatic di- or polyglycidyl ether, derived via epoxidation of di- or polyfunctional alcohols with aliphatic linear, aliphatic branched, or cycloaliphatic moieties consisting of 2-40 carbon atoms, for example ethanediol diglycidyl ether, propanediol diglycidyl ether, isosorbide diglycidyl ether, 1,4-butanediol diglycidyl ether, 1,6-hexanediol diglycidyl ether, octanediol diglycidyl ether, trimethylolpropane polyglycidyl ether, glycerol polyethylene triglycidyl ether, 2-ethyl hexyl diglycidyl ether, isosorbide diglycidyl ether, bisphenol A diglycidyl ether, bisphenol F diglycidyl ether, bisphenol S diglycidyl ether.

Most preferred the polyepoxide compound (B) is selected from the group consisting of ethanediol diglycidyl ether, butanediole diglycidyl ether, hexanediol diglycidyl ether, trimethylopropane triglycidyl ether, glycerol triglycidyl ether.

A mixture of two or more of the aforementioned polyepoxide compounds (B) can also be used.

As used herein, the term “aliphatic polyepoxide compound” is meant to denote compounds having two or more epoxide groups and also aliphatic moieties. The aliphatic polyepoxide compound means an araliphatic or a cycloaliphatic polyepoxide compound.

In a preferred embodiment of the invention the polyepoxide compound (B) is an aliphatic polyepoxide compound (B-1).

In a preferred embodiment of the invention, the aliphatic polyepoxide compound (B-1) is one or more compound(s) and is selected from the group consisting of neopentyl glycol diglycidyl ether, hydrogenated bisphenol A diglycidyl ether, 1,4-cyclohexane dicarboxylic acid diglycidyl ester, ethylene glycol diglycidyl ether, polyethylene glycol diglycidyl ether, diethylene glycol diglycidyl ether, propylene glycol diglycidyl ether, dipropylene glycol diglycidyl ether, polypropylene glycol diglycidyl ether, glycerol triglycidyl ether, polyglycerol polyglycidyl ether, polyglycidyl ether of ethoxylated trimethylolpropane, poly(tetramethylene-oxid) diglycidyl ether, pentaeritrol polyglycidyl ether, vinylcyclohexene diepoxide, the diepoxides of double unsaturated fatty acid CI - C18 alkyl esters, polyepoxides of double unsaturated ethoxy lated fatty alcohols, aliphatic di- or polyglycidyl ether, derived via epoxidation of di- or polyfunctional alcohols with aliphatic linear, aliphatic branched, or cycloaliphatic moieties consisting of 2-40 carbon atoms, for example ethanediol diglycidyl ether, propanediol diglycidyl ether, 1,4-butanediol diglycidyl ether, 1,6-hexanediol diglycidyl ether, octanediol diglycidyl ether, trimethylolpropane polyglycidyl ether, glycerol polyethylene triglycidyl ether, 2-ethyl hexyl diglycidyl ether, isosorbide diglycidyl ether,

In a more preferred embodiment of the invention, the aliphatic polyepoxide compound (B-1) is one or more compound(s) and is selected from the group consisting of hydrogenated bisphenol A diglycidyl ether, polyethylene glycol diglycidyl ether, polypropylene glycol diglycidyl ether, glycerol triglycidyl ether, polyglycidyl ether of ethoxylated trimethylolpropane, poly (tetramethylene-oxid) diglycidyl ether, pentaeritrol polyglycidyl ether, the diepoxides of double unsaturated fatty acid C1-C18 alkyl esters, aliphatic di- or polyglycidyl ether, derived via epoxidation of di- or polyfunctional alcohols with aliphatic linear, aliphatic branched, or cycloaliphatic moieties consisting of 2-40 carbon atoms, for example ethanediol diglycidyl ether, 1,4-butanediol diglycidyl ether, 1,6-hexanediol diglycidyl ether, trimethylolpropane polyglycidyl ether, glycerol polyethylene triglycidyl ether, 2-ethyl hexyl diglycidyl ether, isosorbide diglycidyl ether.

Most preferred the aliphatic polyepoxide compound (B-1) is one or more compound(s) and is selected from the group consisting of ethanediol diglycidyl ether, butanediole diglycidyl ether, hexane diol diglycidyl ether, trimethylolpropane triglycidyl ether, and glycerol triglycidyl ether.

A mixture of two or more of the aforementioned aliphatic polyepoxide compounds (B-1) can also be used.

As used herein, the term “aromatic polyepoxide compound” is meant to denote compounds having two or more epoxide groups and also aromatic moieties.

In an alternative preferred embodiment of the invention the polyepoxide compound (B) is an aromatic polyepoxide (B-2).

In a preferred embodiment of the invention, aromatic polyepoxide compound (B-2) is one or more compound(s) and is selected from the group consisting of resorcinol diglycidyl ether, bisphenol A diglycidyl ether, bisphenol F diglycidyl ether, bisphenol S diglycidyl ether, 9,9-bis(4-glycidyloxy phenyl)fluorine, tetrabromo bisphenol A diglycidyl ether, tetrachloro bisphenol A diglycidyl ether, tetramethyl bisphenol A diglycidyl ether, tetramethyl bisphenol F diglycidyl ether, tetramethyl bisphenol S diglycidyl ether, diglycidyl terephthalate, diglycidyl o-phthalate, trimellitic acid triglycidyl ester, 1,4-cyclohexane dicarboxylic acid diglycidyl ester, 2-dihydroxy benzene diglycidyl ether, 1,4-dihydroxy benzene diglycidyl ether, 4,4′-(3,3,5-trimethylcyclohexyliden)bisphenyl diglycidyl ether, diglycidyl isophthalate, tetrabromobisphenol A, cardanol-based diglycidyl ether, Hydrochinone diglycidyl ether, 4,4′-dihydroxyphenyl diglycicdyl ether, Bis-(4-hydroxyphenyl)-1,1-ethane diglycidyl ether, Bis-(4-hydroxyphenyl)-1, 1-isobutane diglycidyl ether, Bis-(4-hydroxyphenyl) ether diglycidyl ether, as well as chlorinated and brominated varieties of the aforementioned components.

In a more preferred embodiment of the invention, aromatic polyepoxide compound (B-2) is one or more compound(s) and is selected from the group consisting of bisphenol A diglycidyl ether, bisphenol F diglycidyl ether, bisphenol S diglycidyl ether, tetramethyl bisphenol A diglycidyl ether, tetramethyl bisphenol F diglycidyl ether, tetramethyl bisphenol S diglycidyl ether, diglycidyl terephthalate, diglycidyl o-phthalate, 2-dihydroxybenzene diglycidyl ether, 1,4-dihydroxy benzene diglycidyl ether, 4,4′-(3,3,5-trimethylcyclohexyliden)bisphenyl diglycidyl ether, diglycidyl isophthalate, cardanol-based diglycidyl ether, Hydrochinone diglycidyl ether, 4,4′-dihydroxyphenyl diglycicdyl ether, Bis-(4-hydroxyphenyl)-1,1-ethane diglycidyl ether, Bis-(4-hydroxyphenyl)-1, 1-isobutane diglycidyl ether, Bis-(4-hydroxyphenyl) ether diglycidyl ether.

In a most preferred embodiment of the invention, aromatic polyepoxide compound (B-2) is one or more compound(s) and is selected from the group consisting of bisphenol A diglycidyl ether, bisphenol F diglycidyl ether, bisphenol S diglycidyl ether, tetramethyl bisphenol A diglycidyl ether, tetramethyl bisphenol F diglycidyl ether, tetramethyl bisphenol S diglycidyl ether, diglycidyl terephthalate, 2-dihydroxybenzene diglycidyl ether, 1,4-dihydroxy benzene diglycidyl ether, diglycidyl isophthalate,

A mixture of two or more of the aforementioned aromatic polyepoxide compounds (B-2) can also be used.

In a first alternative preferred embodiment of the invention the polyisocyanate compound (A) is an aliphatic polyisocyanate compound (A-1) and the polyepoxide compound (B) is an aliphatic polyepoxide compound (B-1).

In a second alternative less-preferred embodiment of the invention the polyisocyanate compound (A) is an aliphatic polyisocyanate compound (A-1) and the polyepoxide compound (B) is an aromatic polyepoxide compound (B-2).

In a third alternative less-preferred embodiment of the invention the polyisocyanate compound (A) is an aromatic polyisocyanate compound (A-2) and the polyepoxide compound (B) is an aliphatic polyepoxide compound (B-1).

In a fourth alternative less-preferred embodiment of the invention the polyisocyanate compound (A) is an aromatic polyisocyanate compound (A-2) and the polyepoxide compound (B) is an aromatic polyepoxide compound (B-2).

A mixture of one or more of the aforementioned aliphatic polyisocyanates (A-1), aromatic polyisocyanate compound (A-2), aliphatic polyepoxide compound (B-1) and/or aromatic polyepoxide compound (B-2) can also be used.

In a preferred embodiment of the invention, the molar ratio of the isocyanate groups of the polyisocyanate compound (A) to the epoxy groups of the polyepoxide compound (B) is from 2.6:1 to 7.0:1, preferably from 2.7:1 to 6.0:1 more preferably from 2.8:1 to 5.5:1. If the molar ratio of the isocyanate groups of the polyisocyanate compound (A) to the epoxy groups of the polyepoxide compound (B) is lower than 2.6:1 the viscosity of the resulting isocyanate-group terminated polyoxazolidinone composition comprising the isocyanate-group terminated polyoxazolidinone significantly increases.

In a preferred embodiment of the invention, the process comprising:

a) placing the solvent (D) and the catalyst (C) in the reactor to provide a mixture (a) b) placing the polyisocyanate compound (A) and the polyepoxide compound (B) in a second vessel to provide a mixture (b) c) adding the mixture (b) to the mixture (a) to form the isocyanate-group terminated polyoxazolidinone composition (c).

d) optionally removal of solvent (D) and/or unreacted polyisocyanate compound (A) from the isocyanate-group terminated polyoxazolidinone composition (c) forming the isocyanate-group terminated polyoxazolidinone (d).

In a first alternative preferred embodiment of the invention, the process comprises the steps:

i) Mixing the polyisocyanate compound (A), the polyepoxide compound (B), the catalyst (C) and optionally the solvent (D) forming a mixture (i);

ii) Copolymerizing the mixture (i) forming the isocyanate-group terminated polyoxazolidinone composition (ii) iii) optionally removal of solvent (D) and/or unreacted polyisocyanate compound (A) from the isocyanate-group terminated polyoxazolidinone composition (ii) forming the isocyanate-group terminated polyoxazolidinone (iii).

In a second alternative preferred embodiment of the invention, the process comprises the steps:

alpha) Mixing the polyepoxide compound (B), at least part of the catalyst (C) and optionally at least part of the solvent (D) forming a mixture (alpha):

beta) Addition of the polyisocyanate compound (A) to the mixture (alpha) at copolymerization conditions forming an isocyanate-group terminated polyoxazolidinone composition (beta):

gamma) optionally removal of solvent (D) and/or unreacted polyisocyanate compound (A) from the isocyanate-group terminated polyoxazolidinone composition (beta) forming a isocyanate-group terminated polyoxazolidinone (gamma).

In a third alternative, less-preferred embodiment of the invention, the process comprises the steps:

(1) Mixing the polyisocyanate compound (A) and at least part of the catalyst (C) and at least part of the solvent (D) forming a mixture (1):

(2) Addition of the polyepoxide compound (B) to the mixture (a) at copolymerization conditions forming an isocyanate-group terminated polyoxazolidinone composition (2):

(3) Optionally removal of solvent (D) and/or unreacted polyisocyanate compound (A) from the isocyanate-group terminated polyoxazolidinone composition (2) forming the isocyanate-group terminated polyoxazolidinone (3).

In a preferred embodiment of the invention the catalyst (C) comprises tetraalkylphosphonium halogenide, a tetracycloalkylphosphonium halogenide, and a tetraarylphosphonium halogenide, or a combination thereof, preferably a tetraarylphosphonium halogenide.

In a more preferred embodiment of the invention the catalyst (C) is at least one compound selected from the group consisting of tetraphenylphosphonium chloride, tetraphenylphosphonium bromide, tetraphenylphosphonium iodide, bis(triphenylphosphine)iminium chloride, tetraphenylphosphonium nitrate, ,tetraphenylphosphonium carbonate preferably tetraphenylphosphonium chloride, tetraphenylphosphonium bromide and tetraphenylphosphonium iodide and more preferably tetraphenylphosphonium chloride and tetraphenylphosphonium bromide.

In one embodiment of the method according to the invention, the catalyst (C) is present in a molar amount of >20 ppm to ≤25000 ppm, preferably in an amount of >50 ppm to ≤ 20000 ppm, more preferred of ≥ 100 ppm to ≤ 12000 ppm, based on the theoretical mass of the employed monomers (sum of the mass of polyisocyanate compound and the polyepoxide compound (B)).

In an embodiment of the invention the solvent (D) is used.

In an embodiment of the invention the calculated mass ratio of the sum of diisocyanate compound (A), the bisepoxide compound (B), and catalyst (C) with respect to the sum of diisocyanate compound (A), the bisepoxide compound (B), the catalyst (C), and the solvent (D) ranges from 40 wt-% to 100 wt-%, preferred from 50 wt-% to 90 wt-% and more preferred from 60 wt-% to 80 wt-%.

The solvent (D) is defined in alignment to the general definition as a substance that dissolves a solute, i.e. compound (A) and/or compound (B) and/or compound (C) but does not (chemically) react with compound (A), compound (B) and/or the catalyst (C), in particular the polyisocyanate compound (A).

Suitable solvents (D) according to the invention are non-protic halogenated aromatic solvents, high-boiling non-protic aliphatic heterocyclic solvents, halogenated aromatic or aliphatic heterocyclic solvents with a boiling point equal or lower than 200° C., preferably equal or lower than 190° C. and more preferably equal or lower than 180° C. at 1 bar (absolute).

In an preferred embodiment of the invention the copolymerization is in the presence of a solvent (D) wherein the solvent (D) is one or more compounds and is selected from the group consisting of chlorobenzene, the different isomers of chlorobenzene, the different isomers of dichlorobenzene, dimethylformamide, N,N-dimethylacetamide, tetrahydrofurane, acetone, methyl ethyl ketone, 1,2-Dimethoxyethane, 1-Methoxy-2-(2-methoxyethoxy)ethane, the different isomers of dioxane preferably chlorobenzene and o-dichlorobenzene.

The reaction according to the invention is performed in the absence of a solvent (E) with a boiling point higher than 200° C., preferably higher than 190° C. and more preferably higher than 180° C at 1 bar (absolute).

Such solvents (E) include for example cyclic carbonate, such as ethylencarbonate or propylencarbonate, N-methylpyrrolidone (NMP) and sulfolane. The absence of this additional solvent (E) reduces the energy-intensive and time-consuming removal process, e.g. distillation, of this high boiling solvents.

In the absence of an additional solvent (E) means solvent amounts of (E) of less than 5 wt-% preferably 4 wt-% more preferably 2 wt-%.

Another aspect of the present invention is an isocyanate-group terminated polyoxazolidinone, composition obtainable by a method according to the invention.

In an embodiment of the invention, the isocyanate-group terminated polyoxazolidinone composition has a viscosity of less than 5000 mPa's preferably of from 5 mPa's to 2000 mPa's and more preferably of from 10 mPa's to 1000 mPas, wherein the viscosity is determined via a cone/plate rheometer from Anton Paar MCR 302. A shear rate 63 1·min-1 was used to determine the viscosity of the products. The viscosity is given in the unit mPa·s. (Following the procedure according to DIN EN ISO 3219/A.3:1994). If not indicated otherwise all measurements were performed at 25° C.

In an embodiment of the invention, the isocyanate-group terminated polyoxazolidinones compositions have isocyanate equivalent weights (IEW) of from 50 g/eq to 10000 g/eq, preferably of from 75 g/eq to 6000 g/eq more preferred of from 100 g/eq to 2000 g/eq, wherein the isocyanate equivalent weight was determined via titration according to DIN EN ISO 11909:2007.

The isocyanate equivalent weight (IEW) of the polyoxazolidinone is defined as the total mass of the substance that contains 1 equivalent of isocyanate groups.

In an embodiment of the invention, the isocyanate-group terminated polyoxazolidinones compositions have a oxazolidinone to isocyanurate ratio higher than 2.0:1 preferably of from 2.3:1 to 20.0:1 more preferably of from 2.8:1 to 10.0:1 , wherein the oxazolidione-isocyanurate ratio was determined according to the infra-red measurement method disclosed within the experimental section.

In an embodiment of the invention, the isocyanate-group terminated polyoxazolidinones compositions have an Gardner color index less than 7.0 preferably of from 1.0 to 6.5 more preferably of from 1.5 to 6.0, wherein the Gardner color index was determined according to DIN EN ISO 1557:1997.

Another aspect of the present invention is a process for producing an isocyanate-group terminated polyoxazolidinone (prepolymer), wherein the solvent (D) and/or unreacted polyisocyanate compound (A) is removed from the isocyanate-group terminated polyoxazolidinone composition obtained according the inventive process or the isocyanate-group terminated polyoxazolidinone composition obtainable according to the inventive process.

In an embodiment of the invention, the non-reacted polyisocyanate compound (A) and/or the solvent (D) is removed by thermal treatment method, preferably by distillation and/or by extraction, more preferably by thin-film evaporation.

For the removal of the solvent (D) and/or unreacted polyisocyanate compound (A) in step d), step iii), step gamma) or step (3), appropriate purification methods, e.g. thin film evaporation, can be applied. The removal of the solvent (D) and/or the unreacted polyisocyanate compound (A) can be beneficial for future polymerization applications since e.g. halogen containing solvents and/or the unreacted polyisocyanate compound (A) might disturb these polymerization reactions and negatively impact the resulting polymerization products. Moreover, the removal of the solvent (D) and/or the monomeric polyisocyanate compound (A) leads to a product with lower health risk, as the amount of hazardous monomeric polyisocyanates compound (A) and solvent (D) can be significantly reduced. The remaining isocyanate-group terminated polyoxazolidinone (prepolymer), e.g. the isocyanate-group terminated polyoxazolidinone (d), the isocyanate-group terminated polyoxazolidinone (gamma), isocyanate-group terminated polyoxazolidinone (iii) and the isocyanate-group terminated polyoxazolidinone (3) has a comparably high molecular weight and is not expected to represent a higher risk than other polyisocyanates prepolymers without solvent and with low concentrations of monomeric polyisocyanates compounds.

Another aspect of the present invention is an isocyanate-group terminated polyoxazolidinone obtainable according to the inventive process.

In an embodiment of the invention, the isocyanate-group terminated polyoxazolidinones have isocyanate equivalent weights (IEW) of from 50 g/eq to 10000 g/eq, preferably of from 75 g/eq to 6000 g/eq more preferred of from 100 g/eq to 2000 g/eq, wherein the isocyanate equivalent weight was determined via titration according to DIN EN ISO 11909:2007.

The isocyanate equivalent weight (IEW) of the polyoxazolidinone is defined as the total mass of the substance that contains 1 equivalent of isocyanate groups.

In an embodiment of the invention, the isocyanate-group terminated polyoxazolidinones have a oxazolidinone to isocyanurate ratio higher than 2.0:1 preferably of from 2.3:1 to 20.0:1 more preferably of from 2.8:1 to 10.0:1, wherein the oxazolidinone-isocyanurate ratio was determined according to the infra-red measurement method disclosed within the experimental section.

In an embodiment of the invention, the isocyanate-group terminated polyoxazolidinones have an Gardner color index less than 6.0 preferably of from 1.0 to 5.5 more preferably of from 1.5 to 5.0, wherein the Gardner color index was determined according to DIN EN ISO 1557:1997.

A further aspect of the present invention is an isocyanate-group terminated polyoxazolidinone (prepolymer) according to formula (I) formula (II) and/or formula (III)

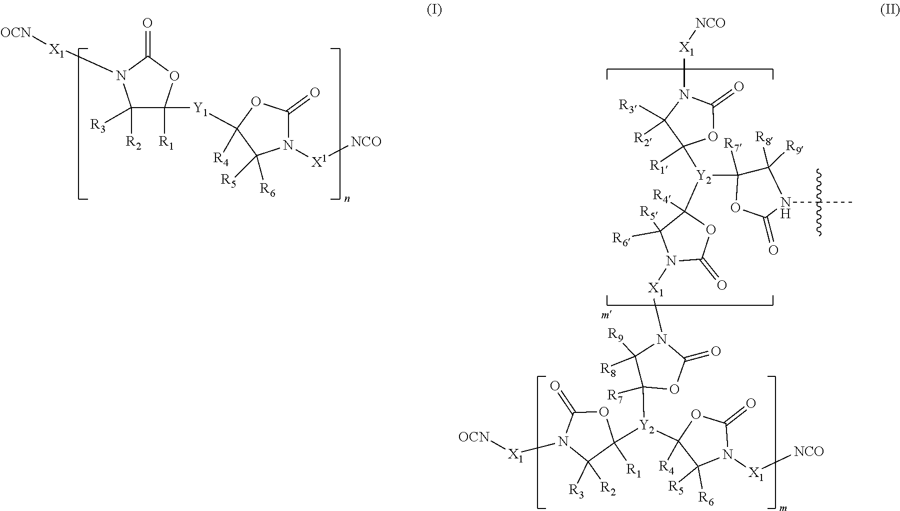

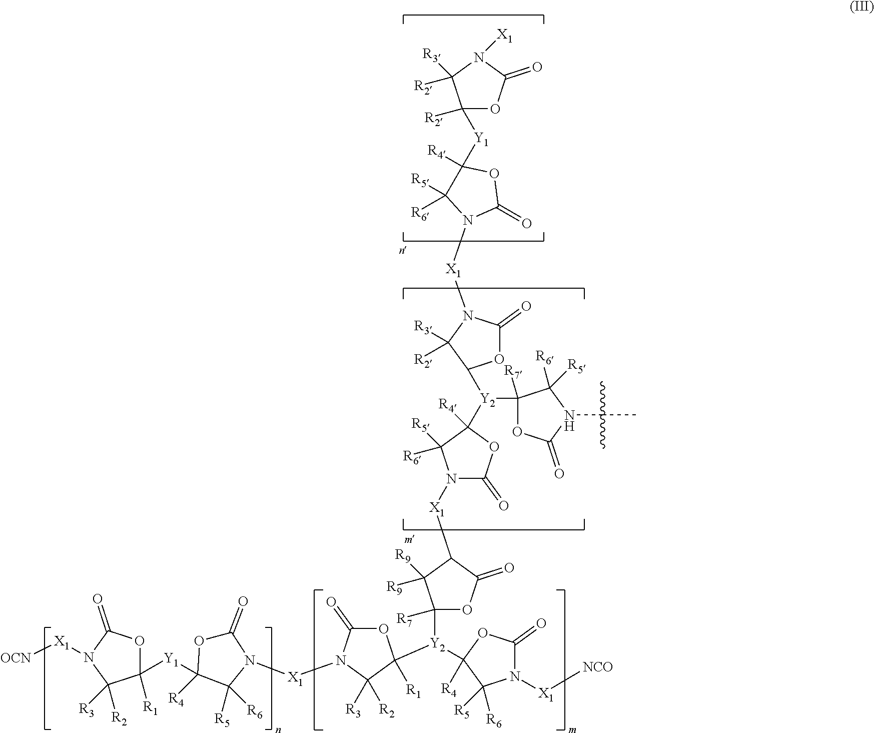

wherein

X1 represents methylene, dimethylene, trimethylene, tetramethylene, pentamethylene, hexamethylene, heptamethylene, octamethylene, nonamethalene, decamethylene, unadecamethylene, dodecamethylene optionally substituted with heteroatoms containing groups, cyclohexylene, phenylene, diphenylene, dimethyl phenylene optionally comprising heteroatoms, 2-methylpentamethylene, 2,2,4-trimethyl-hexamethylene, dodecanemethylene, 1,2-cyclohexylene, 1,3-cyclohexylene, 1,4-cyclohexylene, 5-(1-methylene-(1,3,3-trimethylcyclohexane)), all regioisomers of methylene biscyclohexylene, all regioisomers of methylenebisphenylene, methylenebis-(3,3′-dimethylcyclohexane1,4-diyl), propane-2,2-diyl)bis(cyclohexane-4,1-diyl), propane-2,2-diyl-bis-4,1-phenylene, polyhexamethylene, tolylene, poly(propylene glycol) tolylene, poly(ethylene adipate) tolylene, 2,4,6-trimethyl-1,3-phenylene, 4-chloro-6-methyl-1,3-phenylene, poly [1,4-phenylene], co-poly(1,4-butanediol)], poly(tetrafluoroethylene oxide-co-difluoromethylene oxide), 1,3-bis(1-methylethyl)benzene, 3,3′-dimethyl-4,4′ -bipheny lene, naphthalene, 1,2-phenylene, 1,3- phenylene, 1,4-phenylene 2,4- or 2,5- or 2,6- tolylene or mixtures of these isomers, methylene 4,4′- or 2,4′- or 2,2′- bisphenylene or mixtures of these isomers, 4,4′-, 2,4′- or 2,2′- 2,2′-diphenylpropane-p-xylylene and a,a,a′,a′-tetramethyl-m- or -p-xylylene: preferably hexamethylene diisocyanate, petamethylene diisocyanate or 5-(1-methylene-(1,3,3-trimethylcyclohexane))

Y₁ represents methylene, dimethylene, trimethylene, tetramethylene, pentamethylene, hexamethy lene, heptamethylene, octamethylene, polyethylene, polyethyleneglycol, 1,2-cyclohexylene, 1,3-cyclohexylene, 1,4-cyclohexylene, 1,2-phenylene, 1,3-phenylene, 1,4-phenylene, 1,2-tolylene, 1,3-tolylene, 1,4-tolylene, 4,4′-methylenebis(4, 1-phenylene), 4,4′-methylenebis(cyclohexane-4, 1-diyl), 4,4′-(propane-2,2-diyl)bis(4, 1-phenylene), propane-2,2-diyl-bis(cyclohexane-4, 1-diyl) or Y1 can be represented by formula IV,

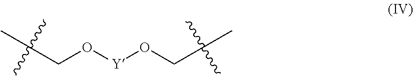

wherein Y′ is represented by methylene, dimethylene, trimethylene, tetramethylene, pentamethylene, hexamethylene, heptamethylene, octamethylene, polyethylene, polyethyleneglycol, 1,2-cyclohexylene, 1,3-cyclohexylene, 1,4-cyclohexylene, 1,2-phenylene, 1,3-phenylene, 1,4-phenylene, 1,2-tolylene, 1,3-tolylene, 1,4-tolylene, 4,4′-methylenebis(4,1-phenylene), 4,4′-methylenebis(cyclohexane-4, 1-diyl), 4,4′-(propane-2,2-diyl)bis(4, 1-phenylene), propane-2,2-diyl-bis(cyclohexane-4, 1-diyl) or 4,4′-(3,3,5-trimethylcyclohexy liden)bisphenyl, preferably dimethy lene, tetramethylene or hexamethy lene, most preferred tetramethy lene,

Y2 can be represented by formula V

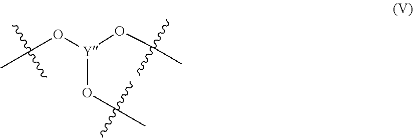

wherein Y″ is represented by 1-(2,2-dimethylene)butane, 1,2,3-propane, 1,3-(2,2-dimethy lene)propane, polycresyl polyglycidyl ether, novolac type glycidyl ether, preferably 1-(2,2-dimethy lene)butane, 1,2,3-propane, or 1,3-(2,2-dimethylene)propane.

The illustrated molecular structures (II) and (III) illustrate exemplary parts of the whole prepolymer scaffold. Consequently, the scattered bond crossed with a wavy line represents the continuation of the partial structure. On the one hand, the substructures can be continued by single monomer building blocks, on the other hand by further (multi-dimensional) chain prolongation analogue to the depicted partial structure.

R1, R1′, R2, R2′, R3, R3′, R4, R4′, R5, R5′, R6, R6′, R7, R7′, R8, R8′, R9, R9′ independent of one another represent hydrogen, chloride, bromide, fluoride, methyl, ethyl, propyl, n-propyl, isopropyl, n-butyl, isobutyl, 2-butyl, tert-butyl, hexyl, methoxy, ethoxy, butoxy, phenyl, methoxyphenyl, chlorophenyl, bromophenyl, nitrophenyl, cyclobutyl, cyclopentyl, cyclohexyl, cycloheptyl.

X1, Y1, Y2, can be equal or different to each other,

R1, R1′, R2, R2′, R3, R3′, R4, R4′, R5, R5′, R6, R6′, R7, R7′, R8, R8′, R9, R9′ can be equal or different to each other, and m, n, m′, n′ are an integer with (m+n+m′+n′) >1, preferably 1 ≤ (m+n+m′+n′)≤100 more preferably 1≤(m+n+m′+n′)≤50, most preferably 1≤(m+n+m′+n′)≤30.

In an embodiment of the invention, the isocyanate-group terminated polyoxazolidinones according to formula (I) formula (II) and/or formula (III) have isocyanate equivalent weights (IEW) of from 50 g/eq to 10000 g/eq, preferably of from 75 g/eq to 6000 g/eq more preferred of from 100 g/eq to 2000 g/eq, wherein the isocyanate equivalent weight was determined via titration according to DIN EN ISO 11909:2007.

The isocyanate equivalent weight (IEW) of the polyoxazolidinone polyoxazolidinones according to formula (I) formula (II) and/or formula (III) is defined as the total mass of the substance that contains 1 equivalent of isocyanate groups.

In an embodiment of the invention, the isocyanate-group terminated polyoxazolidinones according to formula (I) formula (II) and/or formula (III) have a oxazolidinone to isocyanurate ratio higher than 2.0:1 preferably of from 2.3:1 to 20.0:1 more preferably of from 2.8:1 to 10.0:1, wherein the oxazolidione-isocyanurate ratio was determined according to the infra-red measurement method disclosed within the experimental section.

In an embodiment of the invention, the isocyanate-group terminated polyoxazolidinones polyoxazolidinones according to formula (I) formula (II) and/or formula (III) have an Gardner color index less than 6.0 preferably of from 1.0 to 5.5 more preferably of from 1.5 to 5.0, wherein the Gardner color index was determined according to DIN EN ISO 1557:1997.

### EXAMPLES

The present invention will be further described with reference to the following examples without wishing to be limited by them.

Diisocyanate compound (A)

A-I: Isophorone diisocyanate (IPDI), Covestro, AG, Germany.

Epoxide compound (B)

For the calculation of the experimental molar ratios, a compound purity of 100% was assumed for the diepoxides compounds. Possible impurities e.g. alcoholic compounds were neglected for the calculations.

B-I: IPOX RD3 Butanediol diglycidyl ether (BDDE), EEW 130-145 g/eq; was obtained from Ipox Chemicals GmbH, Germany.

Since Ipox RD 3 provides a significant amount of compounds which are not the ideal structure (BDDE), a correction factor f for the calculation of the effective molar amount of epoxy groups was calculated on the basis of the following formula:

$$f ( correction ) = \frac{Mw ( BDDE ) ( Ideal structure )}{EEW * Functionality} = \frac{202.25 g / mol}{132 * 2} = 0.766$$

### Catalyst (C)

C-I: TPPCI Tetraphenylphosphoniumchloride, purity 98%, was obtained from Sigma Aldrich

C-II: TPPBr Tetraphenylphosphoniumbromide, purity >99%, was obtained from Sigma Aldrich

C-II: TPPI Tetraphenylphosphoniumiodide, was obtained from Merck Schuchardt OHG

C-III: LiCl Lithium chloride, was obtained by Sigma Aldrich with >99% purity

C-IV: LiBr Lithium bromide, purity >99,9%, was obtained from Acros Organics

C-V: Yb(OTf)₃ Ytterbiumtris(trifluoromethansulfonat), 99.9%, was obtained from Acros Organics

C-VI: TBABr Tetrabutylammoniumbromide>99% was obtained from Acros Organics

C-VII: EMIMCI 1-Ethyl-3-Methylimidazoliumchlorid: >97% was obtained by Acros Organics

C-VIII: BMPCI 1-Butyl-1-Methylpiperidiniumchlorid: 99% was obtained by Iolitec Ionic Liquids Technologies GmbH

C-IX: Sb(Ph)₃ Tripheny lantimony (III) (Triphenyl stibine (III)): 99% was obtained from Sigma Aldrich

C-X: I₂ Iodine: >99.8% was obtained from Sigma Aldrich

The concentration of catalyst is given in ppm related to the theoretical mass of the employed monomers.

Solvents (D) D-I: Ortho-dichlorobenzene (o-DCB), purity 99%, anhydrous, was obtained from Sigma-Aldrich, Germany.

### Solvents (E)

E-I: Sulfolane, purity >99%, anhydrous, was obtained from Sigma-Aldrich, Germany.

o-DCB, IPDI, LiCI, LiBr, TPPCI, TPPBr, TPPI, TBABr, EMIMCI, BMPCI, and the BDDE were used as received without further purification. Sulfolane was used after melting at 50° C. and drying over molecular sieves.

Characterization of polyoxazolidinone prepolymers

### Infra-Red Analysis (IR)

IR analyses were performed on a Bruker ALPHA-P IR spectrometer equipped with a diamond probe head. The software OPUS 6.5 was used for data treatment. A background spectrum was recorded against ambient air. Thereafter, a small sample of the polyoxazolidinone prepolymer (ca. 2 mg) was applied to the diamond probe and the IR spectrum recorded averaging over 24 spectra obtained in the range of 4000 to 400 cm⁻¹ with a resolution of 4 cm⁻¹.

The peak height ratio of oxazolidinone to isocyanurate was calculated according to:

$$( 1 )$$

$$Ratio ( oxazolidinone : isocyanurate ) = \frac{peak height ( oxazolidinone )}{peak height ( isocyanurate )}$$

using the peak height of the peak at 1749 cm⁻¹ for the oxazolidinone und the height of the peak at 1685 cm⁻¹ for the isocyanurate.

### Color Index

The Gardner color index was determined by using a Lico 620 from Hach. Therefore, a sample of the isocyanate-group terminated polyoxazolidinone composition was filled into a cuvette which was subsequently analyzed following the DIN EN ISO 1557:1997. The isolated isocyanate group terminated polyoxazolidinone prepolymer was dissolved in o-DCB (68 wt % solid content) prior to the color index measurement.

### Viscosity Measurements

The viscosity values were determined via a cone/plate rheometer from Anton Paar MCR 302. A shear rate 63 1·min-1 was used to determine the viscosity of the products. The viscosity is given in the unit mPa·s. (Following the procedure according to DIN EN ISO 3219/A.3:1994). If not indicated otherwise all measurements were performed at 25° C.

### GPC

GPC measurements were performed at 40° C. in tetrahydrofuran (THF, flow rate of 1.0 mL min⁻¹). The column set consisted of 4 consecutive columns (2×PSS, SDV 50 A, 5 μL, and 2×PSS, SDV 100 A, 5 μL)). Samples (concentration 2-3 g L⁻¹, injection volume 100 μL) were injected. An RID detector of the Agilent 1200 series was used to follow the concentration at the exit of the column. Raw data were processed using the PSS WinGPC Unity software package. Polystyrene of known molecular weight was used as reference to calculate the molecular weight distribution (PSS Ready Cal Kit in an area of 266 Da to 66.000 Da was used). The number average molecular weight measured by GPC is denominated as M.(GPC) in the examples.

### Reactor

The reaction was performed in a 250 mL 4 neck round bottom flask equipped with a glass reflux condenser, a gas inlet (N2), a syringe pump (IP-SYRDOS2-HP-XLP from SyrDos), a glass inlet tube equipped with a temperature probe (GFX 460 from Ebro) and an overhead KPG agitator (RW20 from IKA). The round bottom flask was heated with a heating mantle from Winkler (WM/BRI/250 with a maximum heating capacity of 120 W) which was connected to the temperature probe with an RB 1691 B-S from Ebro.

Example 1 (comp.): Synthesis of isocyanate-terminated polyoxazolidinone-based composition with IPDI as compound (A-I) and with IPOX RD 3 as compound (B-I) using LiCI (C-III) as compound (C) and a solvent mixture comprising o-DCB as compound (D-I) and sulfolane as compound (E-I) in a semi-batch procedure with molar ratio of isocyanate groups to epoxy groups of 5.7:1. A reactor as previously described was charged with LiCI (79.5 mg, 788 ppm) (C-III). Then sulfolane (9.0 mL) (E-I) was added and the mixture was stirred (400 rpm) and flushed with nitrogen (ca. 1 mL/min) for 30 min. Subsequently, the mixture was heated to 175° C. before o-DCB (D-I) (17 mL) was added. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 2 (comp.): Synthesis of isocyanate-terminated polyoxazolidinone-based composition with IPDI as compound (A-I) and with IPOX RD 3 as compound (B-I) using LiCI (C-III) as compound (C) and a solvent mixture comprising o-DCB as compound (D-I) in a semi-batch procedure with molar ratio of isocyanate groups to epoxy groups of 5.7:1.

A reactor as previously described was charged with LiCI (79.5 mg, 788 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 3 (comp.): Synthesis of isocyanate-terminated polyoxazolidinone-based composition with IPDI as compound (A-I) and with IPOX RD 3 as compound (B-I) using TBABr (C-VI) as compound (C) and a solvent mixture comprising o-DCB as compound (D-I) in a semi-batch procedure with molar ratio of isocyanate groups to epoxy groups of 5.7:1.

A reactor as previously described was charged with TBABr (604 mg, 5960 ppm) (C-VI). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g. 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 4 (Comp.): Synthesis of isocyanate-terminated polyoxazolidinone-based composition with IPDI as compound (A-I) and with IPOX RD 3 as compound (B-I) using TBABr (C-VI) as compound (C) in a semi-batch procedure with molar ratio of isocyanate groups to epoxy groups of 5.7:1. A reactor as previously described was charged with TBABr (604 mg, 5960 ppm) (C-VI). Then IPDI (16.67 g, 0.075 mol) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I) and IPDI (66.69 g, 0.30 mol) (A-I) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 5 (comp.): Synthesis of isocyanate-terminated polyoxazolidinone-based composition with IPDI as compound (A-I) and with IPOX RD 3 as compound (B-I) using EMIMCI (C-VII) as compound (C) and a solvent mixture comprising o-DCB as compound (D-I) in a semi-batch procedure with molar ratio of isocyanate groups to epoxy groups of 5.7:1.

A reactor as previously described was charged with EMIMCI (275 mg, 2720 ppm) (C-VII). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 6 (comp.): Synthesis of isocyanate-terminated polyoxazolidinone-based composition with IPDI as compound (A-I) and with IPOX RD 3 as compound (B-I) using BMPCI (C-VIII) as compound (C) and a solvent mixture comprising o-DCB as compound (D-I) in a semi-batch procedure with molar ratio of isocyanate groups to epoxy groups of 5.7:1.

A reactor as previously described was charged with BMPCI (348 mg, 3442 ppm) (C-VIII). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 7 (comp.): Synthesis of isocyanate-terminated polyoxazolidinone-based composition with IPDI as compound (A-I) and with IPOX RD 3 as compound (B-I) using LiBr (C-IV) as compound (C) and a solvent mixture comprising o-DCB as compound (D-I) and sulfolane as compound (E-I) in a semi-batch procedure with molar ratio of isocyanate groups to epoxy groups of 5.7:1.

A reactor as previously described was charged with LiBr (163 mg, 1613 ppm) (C-IV). Then sulfolane (9.0 mL) (E-I) was added and the mixture was stirred (400 rpm) and flushed with nitrogen (ca. 1 mL/min) for 30 min. Subsequently, the mixture was heated to 175° C. before o-DCB (D-I) (17 mL) was added. Next, a mixture of IPOX RD3 (17.44 g, 0.066 mol) (B-I). IPDI (83.36 g, 0.375 mol) (A-I). and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 8 (comp.): Synthesis of isocyanate-terminated polyoxazolidinone-based composition with IPDI as compound (A-I) and with IPOX RD 3 as compound (B-I) using Yb(OTf)₃(C-V) as compound (C) and a solvent mixture comprising o-DCB as compound (D-I) in a semi-batch procedure with molar ratio of isocyanate groups to epoxy groups of 5.7:1.

A reactor as previously described was charged with Yb(OTf)₃ (1163 mg, 11406 ppm) (C-V). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 9: Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 5.7:1.

A reactor as previously described was charged with TPPCI (703 mg, 6924 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 10: Synthesis of isocyanate-terminated polyoxazolidinone-based composition with IPDI as compound (A-I) and with IPOX RD 3 as compound (B-I) using TPPBr (C-II) as compound (C) and a solvent mixture comprising o-DCB as compound (D-I) in a semi-batch procedure with molar ratio of isocyanate groups to epoxy groups of 5.7:1.

A reactor as previously described was charged with TPPBr (786 m, 7739 ppm) (C-II). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g. 0.066 mol) (B-I), IPDI (83.36 g. 0.375 mol) (A-I), and o-DCB (11 mL) (D-1) was added in, a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 11: Synthesis of isocyanate-terminated polyoxazolidinone-based composition with IPDI as compound (A-I) and with IPOX RD 3 as compound (B-I) using TPPI (C-III) as compound (C) and a solvent mixture comprising o-DCB as compound (D-I) in a semi-batch procedure with molar ratio of isocyanate groups to epoxy groups of 5.7:1.

A reactor as previously described was charged with TPPI (874 mg, 8599 ppm) (C-III). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 12: Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 4:1.

A reactor as previously described was charged with TPPCI (703 mg, 6443 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (25.03 g, 0.095 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 13: Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 3.3:1.

A reactor as previously described was charged with TPPCI (703 mg, 6148 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (30.26 g, 0.115 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 14: Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 2.2:1.

A reactor as previously described was charged with TPPCI (703 mg, 5431 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (45.35 g, 0.172 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 15: Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 8.7:1.

A reactor as previously described was charged with TPPCI (703 mg, 7364 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175° C. Next, a mixture of IPOX RD3 (11.38 g, 0.043 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 16 (comp.): Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 36.3:1.

A reactor as previously described was charged with TPPCI (703 mg, 8089 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175° C. Next, a mixture of IPOX RD3 (2.73 g, 0.010 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

Example 17 (congruent with example 09): Synthesis of isocyanate-terminated polyoxazolidinone-based composition with IPDI as compound (A-I) and with IPOX RD 3 as compound (B-I) using TPPCI (C-I) as compound (C) and a solvent mixture comprising o-DCB as compound (D-I) in a semi-batch procedure with molar ratio of isocyanate groups to epoxy groups of 5.7:1 The polyoxazolidinone-based prepolymer was isolated from the composition via thin film evaporation. A reactor as previously described was charged with TPPCI (703 mg, 6924 ppm) (C-I). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature.

Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore. The isocyanate-terminated polyoxazolidinone-based prepolymer was isolated from the composition by removal of the unreacted monomers and solvent thin film evaporation (180° C. and 0.3 mabar).

Example 18 (comp): Synthesis of isocyanate-terminated polyoxazolidinone-based composition with IPDI as compound (A-I) and with IPOX RD 3 as compound (B-I) using a 1:2 molar mixture of Sb(Ph): (C-IX) and 12 (C-X) as compound (C) and a solvent mixture comprising o-DCB as compound (D-I) in a semi-batch procedure with molar ratio of isocyanate groups to epoxy groups of 5.7:1. A reactor as previously described was charged with Sb(Ph)3 (662 mg, 6460 ppm) (C-IX) and I2 (952 mg, 9294 ppm) (C-X). Then o-DCB (D-I) (25 mL) was added and the mixture was stirred (400 rpm) and flushed with nitrogen (ca. 1 mL/min) for 30 min. Subsequently, the mixture was heated to 175°. Next, a mixture of IPOX RD3 (17.44 g, 0.066 mol) (B-I), IPDI (83.36 g, 0.375 mol) (A-I), and o-DCB (11 mL) (D-1) was added in a continuous manner within a time range of 30 minutes by using the syringe pump. After the addition of the monomers was completed, the reaction was stirred and heated for further 210 minutes before the reaction mixture was allowed to cool to room temperature. Within the course of the reaction, samples of the reaction mixture were taken and analyzed by IR-spectroscopy. The completion of the reaction was confirmed by seeing that the isocyanate band (2260 cm⁻¹) in the IR spectrum from the reaction mixture did not change anymore.

TABLE 1
Comparison of the results of Examples 1 to 18.

| | | | | Molar Ratio | | oxazolidinone | Color | |
|---|---|---|---|---|---|---|---|---|
| | | | | isocyanate | Solids | to | number | |
| | | Compound | | groups:epoxy | content | isocyanurate | (Gardner | Viscosity |
| Example | | (C) | (D) | groups | [%] | Ratio | scale) | [mPa · s] |
| 1 (comp.) | Composition | LiCl | o-DCB, | 5.7:1 | 68 | 1.06 | 4.3 | 276 |
| | | | sulfolane | | | | | |
| 2 (comp.) | Composition | LiCl | o-DCB, | 5.7:1 | 68 | 0.21 | 5.3 | 824 |
| 3 (comp.) | Composition | TBABr | o-DCB | 5.7:1 | 68 | 0.29 | 5.2 | 6 |
| 4 (comp.) | Composition | TBABr | — | 5.7:1 | 100 | 0.33 | 4.4 | 16 |
| 5 (comp.) | Composition | EMIMCl | o-DCB | 5.7:1 | 68 | 0.07 | 10.0 | 37 |
| 6 (comp.) | Composition | BMPCl | o-DCB | 5.7:1 | 68 | 0.28 | 8.0 | 5 |
| 7 (comp.) | Composition | LiBr | o-DCB, | 5.7:1 | 68 | 1.33 | 5.2 | 138 |
| | | | sulfolane | | | | | |
| 8 (comp.)^{a)} | Composition | Yb(OTf)₃ | o-DCB | 5.7:1 | 68 | 1.96 | 16.3 | 62 |
| 9 | Composition | TPPCl | o-DCB | 5.7:1 | 68 | 4.12 | 4.4 | 31 |
| 10 | Composition | TPPBr | o-DCB | 5.7:1 | 68 | 3.93 | 3.8 | 31 |
| 11 | Composition | TPPI | o-DCB | 5.7:1 | 68 | 2.39 | 4.8 | 29 |
| 12 | Composition | TPPCl | o-DCB | 4:1 | 68 | 5.03 | 4.5 | 102 |
| 13 | Composition | TPPCl | o-DCB | 3.3:1 | 71 | 4.80 | 5.9 | 276 |
| 14 | Composition | TPPCl | o-DCB | 2.2:1 | 73 | 6.03 | 5.8 | 4304 |
| 15 | Composition | TPPCl | o-DCB | 8.7:1 | 68 | 3.58 | 4.8 | 12 |
| 16 (comp.) | Composition | TPPCl | o-DCB, | 36.3:1 | 68 | 2.15 | 5.3 | 4 |
| 17^{b)} | Prepolymer | TPPCl | — | 5.7:1 | 100 | 3.72 | 4.1 | — |
| 18 (comp.) | Composition | (Ph)₃Sb•2 I₂ | o-DCB | 5.7:1 | 68 | 1.18 | 16.2 | 42 |

comp.: comparative example
^{a)}A heterogeneous reaction mixture with insoluble dark particles was obtained.
^{b)}Prepolymer was dissolved in o-DCB (68 wt % solid content) prior to the color-number measurement.

15. An isocyanate-group terminated polyoxazolidinone obtainable according to claim 14

1. A process for producing an isocyanate-group terminated polyoxazolidinone composition, the process comprising copolymerizing of a polyisocyanate compound (A) with a polyepoxide compound (B) in the presence of a catalyst (C), wherein the polyisocyanate compound (A) comprises two or more isocyanate groups and the polyepoxide compound (B) comprises two or more epoxy groups;
wherein a molar ratio of the isocyanate groups of the polyisocyanate compound (A) to the epoxy groups of the polyepoxide compound (B) is larger than 2:1 and less than 25:1;
and wherein the catalyst (C) is represented by the formula (I)
[M(R1)(R2)(R3)(R4)]⁺ₙYⁿ⁻ (I)
wherein M is phosphorous or antimony,
wherein (R1), (R2), (R3), and (R4) are each, independently of one another, a linear or branched alkyl groups containing 1 to 22 carbon atoms, optionally substituted with one or more heteroatoms, heteroatom containing substituents, or a combination thereof[[;]], a cycloaliphatic groups containing 3 to 22 carbon atoms, optionally substituted with one or more heteroatoms, heteroatom containing substituents, or a combination thereof[[;]], a C1 to C3 alkyl-bridged cycloaliphatic groups containing 3 to 22 carbon atoms, optionally substituted with one or more heteroatoms, heteroatom containing substituents, or a combination thereof, or an aryl groups containing 6 to 18 carbon atoms, optionally substituted with one or more alkyl groups containing 1 to 10 carbon atoms one or more heteroatom containing substituents one or more heteroatoms, or a combination thereof, wherein Y is a halide, carbonate, nitrate, sulfate or phosphate anion, more preferred a and
wherein n is an integer of 1, 2 or 3,
and wherein the process is conducted in the absence of a solvent (E) with a boiling point higher than 200° C. at 1 bar (absolute).

2. The process according to claim 1, wherein the molar ratio of the isocyanate groups of the polyisocyanate compound (A) to the epoxy groups of the polyepoxide compound (B) is from 2.6:1 to 7.0:1.

3. The process according to claim 12, wherein the polyisocyanate compound (A) is an aliphatic polyisocyanate compound (A-1) and/or an aromatic polyisocyanate compound (A-2).

4. The process according to claim 1, wherein the polyepoxide compound (B) is an aliphatic polyepoxide compound (B-1) and/or aromatic polyepoxide compound (B-2).

5. The process according to claim 1, wherein the polyisocyanate compound (A) is an aliphatic polyisocyanate compound (A-1) and the polyepoxide compound (B) is an aliphatic polyepoxide compound (B-1).

6. The process according to claim 3, wherein the aliphatic polyisocyanate compound (A-1) is one or more compound selected from the group consisting of 1,5-diisocyanatopentane, 1,6-diisocyanatohexane, and 1-isocyanato-3,3,5-trimethyl-5-isocyanatomethylcyclohexane.

7. The process according to claim 4, wherein the aliphatic polyepoxide compound (B-1) is one or more compound and is selected from the group consisting of ethanediol diglycidyl ether, butanediole diglycidyl ether, hexane diol diglycidyl ether, trimethylolpropane triglycidyl ether, and glycerol triglycidyl ether.

8. The process according to claim 1, wherein the catalyst (C) comprises a tetraalkylphosphonium halogenide, a tetracycloalkylphosphonium halogenide, a tetraarylphosphonium halogenide, or a combination thereof.

9. The process according to any one of claim[s] 1-to 8, wherein the catalyst (C) is at least one compound selected from the group consisting of tetraphenylphosphonium chloride, tetraphenylphosphonium bromide, tetraphenylphosphonium iodide, bis(triphenylphosphine)iminium chloride, tetraphenylphosphonium nitrate, and tetraphenylphosphonium carbonate.

10. The process according to any one of claim 1, wherein the copolymerization is in the solvent (D) and the solvent (D) is one or more compounds and is-selected from the group consisting of chlorobenzene, the different isomers of dichlorobenzene, dimethylformamide, N,N-dimethylacetamide, tetrahydrofurane, acetone, methyl ethyl ketone, 1,2-Dimethoxyethane, 1-Methoxy-2-(2-methoxyethoxy)ethane, and the different isomers of dioxane.

11. The process according to claim 10 comprising:
a) placing the solvent (D) and the catalyst (C) in the reactor to provide a mixture (a);
b) placing the polyisocyanate compound (A) and the polyepoxide compound (B) in a second vessel to provide a mixture (b); and
c) adding the mixture (b) to the mixture (a) to form an isocyanate-group terminated polyoxazolidinone composition (c).

12. An isocyanate-group terminated polyoxazolidinone composition produced according to the method of claim 1.

13. A process for producing an isocyanate-group terminated polyoxazolidinone from the isocyanate-group terminated polyoxazolidinone composition of claim 1, the process comprising removing a solvent (D) and/or unreacted polyisocyanate compound (A) from the isocyanate-group terminated polyoxazolidinone composition.

14. The process according to claim 13, wherein the [[non-]]unreacted polyisocyanate compound (A) and/or the solvent (D) is removed by a thermal treatment method.

15. An isocyanate-group terminated polyoxazolidinone produced with the process according to claim 14.

16. The process according to claim 1, wherein M is phosphorous.

17. The process according to claim 1, wherein Y is a halide or a carbonate.

18. The process according to claim 2, wherein the molar ratio of the isocyanate groups of the polyisocyanate compound (A) to the epoxy groups of the polyepoxide compound (B) is from 2.8:1 to 5.5:1.

19. The process according to claim 3, wherein the polyisocyanate compound (A) is an aliphatic polyisocyanate compound (A-1).

20. The process according to claim 4, wherein the polyepoxide compound (B) is an aliphatic polyepoxide compound (B-1).
